(19) United States
(12) Patent Application Publication
(10) Pub. No.: US 2008/0306839 A1
(43) Pub. Date: Dec. 11, 2008

(54) METHOD AND APPARATUS FOR ONLINE CHECK PROCESSING

(75) Inventor: Ed STARRS, El Dorado Hills, CA (US)

Correspondence Address: SAWYER LAW GROUP LLP, 2465 E. Bayshore Road, Suite No. 406, PALO ALTO, CA, 94303, US

(73) Assignee: MyECheck, Inc., El Dorado Hills, CA (US)

(21) Appl. No.: 12/144,562

(22) Filed: Jun. 23, 2008

Related U.S. Application Data
(63) Continuation-in-part of application No. 11/413,673, filed on Apr. 28, 2006, now Pat. No. 7,389,913.

(51) Int. Cl. G06Q 30/00

(52) U.S. Cl. 705/27

(57) ABSTRACT

Methods and apparatus for processing an online payment for an item is disclosed. In one implementation, the method includes receiving information from a user corresponding to online payment for an item. The information from the user is received through a graphical user interface, and includes an authorization to pay for the item using an electronic check. The method further includes creating an electronic image of an authorized demand draft based on the authorization received from the user. The electronic image of the authorized demand draft is created directly from the information provided by the user through the graphical user interface. The electronic image includes a stage in which a physical version of the electronic check is printed out from the electronic image, briefly, before being scanned back to electronic format and transmitted.

### CROSS-REFERENCES TO RELATED APPLICATIONS

This application claims the benefit of priority under 35 U.S.C. 120 as a continuation-in-part of U.S. application Ser. No. 11/413,673, entitled “METHOD AND APPARATUS FOR ONLINE CHECK PROCESSING,” filed on Apr. 28, 2006, the contents of which is hereby incorporated by reference in its entirety.

### FIELD OF THE INVENTION

The present invention relates generally to data processing, and more particularly to methods and apparatus for processing a bank instrument.

### BACKGROUND OF THE INVENTION

The development of the Internet has created new online markets and marketplaces. For example, a user (e.g., a consumer) with an Internet connection can search for a variety of items (including, for example, physical products, services, digital media or content, and the like) provided by online merchants. Users can typically pay for items using a number of different online payment processing options. One common online payment processing option includes payment through credit cards. In a typical credit card payment purchasing scheme, a user accesses a website (e.g., of a merchant or other provider of items) and provides required personal information and a credit card number. The merchant submits a charge to a corresponding credit card company, and completes the online payment purchase with the user once the credit card company authorizes the charge. Online merchants, however, are exposed to high costs associated with fraud and charge back fees, and bear liability because typically no credit card signature is required when a user pays online using a credit card.

Another online payment processing option includes payment using electronic checks (referred to herein also as e-checks) through a funds transfer system associated with the Automated Clearing House (ACH) network. The ACH network is an electronic funds transfer system governed by NACHA (National Automated Clearing House Association) which sets operating rules that provide for inter-bank clearing of electronic payments for participating depository financial institutions. However, as with the credit card payment purchasing scheme, payments made using e-checks through a funds transfer system associated with the ACH network can be charged back or reversed long after a transaction date. In addition, not all financial institutions (including banks) participate in the ACH network. Other conventional e-check payment systems typically require merchants (or other check processors) to buy special check printing equipment and proprietary checks, so that the merchants can print out and then deposit physical paper copies of the consumer check. Merchants, however, must typically wait a long period of time (e.g., 5-7 days) for a printed check to clear.

Accordingly, what is needed is an improved online consumer payment solution. The present invention addresses such a need.

### SUMMARY OF THE INVENTION

The present invention provides a system, method, and software instructions for processing online payments.

In one aspect, this specification describes a computer-implemented method for processing an online payment for an item. The method includes receiving information from a user corresponding to the online payment for the item. The information from the user is received through a graphical user interface, and includes an authorization to pay for the item using an electronic check. The method further includes creating an electronic image of an authorized demand draft (or a remotely created check) based on the authorization received from the user. The electronic image of the authorized demand draft is created directly from the information provided by the user through the graphical user interface.

In one embodiment, the method can include a transitory step. More particularly, the electronic image of the authorized demand daft can be printed in order to create a physical manifestation of a check. The physical check can be scanned back to a digital format prior to being transmitted for approval.

in other embodiments, particular implementations can include one or more of the following features. Creating an electronic image of an authorized demand draft can include creating an electronic image of an authorized demand draft that is compliant with the Check Clearing for the 21st Century Act (Check 21) (e.g., a check formatted according to ANSI (American National Standards Institute) X9 standard such as X9.37, X9.100, or the like). The electronic image of the authorized demand draft can be unsigned by the user. The method can further include transmitting the electronic image of the authorized demand draft to a financial institution, and receiving funds from the financial institution based on the electronic image of the authorized demand draft to provide payment for the item. Creating an electronic image of an authorized demand draft, transmitting the electronic image of the authorized demand draft to a financial institution, and receiving funds from the financial institution based on the electronic image of the authorized demand draft can be performed substantially in real-time. The method can further include performing one or more real-time verifications on the user prior to creating the electronic image of the authorized demand draft. Performing one or more real-time verifications on the user can include generating a blended risk score on the user. The blended risk score can correspond to a degree of risk associated with successfully performing an online payment transaction with the user. The blended risk score can be a composite of a plurality of individual risk scores. The information from the user can be received through a graphical user interface associated with a website of a merchant through which the item is purchasable.

In another aspect, this specification describes a check processing system for processing an online payment from a user, in which the online payment is for an item that is purchasable through a website of a merchant. The check processing system includes a first engine to receive information from the user corresponding to the online payment for the item. The information from the user is received through a graphical user interface associated with the website of the merchant. The information from the user includes a name of the user, bank data associated with the user, and an authorization to pay for the item using an electronic check. The check processing system further includes a second engine to create an electronic image of an authorized demand draft based on the authorization received from the user. The electronic image of the authorized demand draft is created directly from the information provided by the user through the graphical user interface associated with the website of the merchant. The electronic image of the authorized demand draft includes the name of the user, the bank data associated with the user. The check processing system further includes a third engine to transmit the electronic image of the authorized demand draft to a financial institution corresponding to the bank data associated with the user, and a fourth engine to receive funds from the financial institution based on the electronic image of the authorized demand draft to provide payment for the item.

Implementations can include one or more of the following features. The fourth engine can be operable to receive the funds from the financial institution substantially in real-time relative to when the electronic image of the authorized demand draft is created and transmitted to the financial institution. The first engine, the second engine, the third engine, and the fourth engine can be components of the same engine. The check processing system can further include a fifth engine operable to perform one or more real-time verifications on the user prior to the second engine creating the electronic image of the authorized demand draft. The fifth engine can be operable to perform one or more real-time verifications including generating a blended risk score on the user.

In another aspect, this specification describes a computer-implemented method for processing an online payment from a user, in which the online payment is for an item that is purchasable through a website of a merchant. The method includes receiving information from the user corresponding to the online payment for the item. The information from the user is received through a graphical user interface associated with the website of the merchant, and includes a name of the user, bank data associated with the user, and an authorization to pay for the item using an electronic check. The method further includes creating an electronic image of an authorized demand draft based on the authorization received from the user. The electronic image of the authorized demand draft is created directly from the information provided by the user through the graphical user interface associated with the website of the merchant, and includes the name of the user, the bank data associated with the user. The method further includes transmitting the electronic image of the authorized demand draft to a financial institution corresponding to the bank data associated with the user, and receiving funds from the financial institution based on the electronic image of the authorized demand draft to provide payment for the item.

Particular implementations can include one or more of the following features. The item can comprise one of a physical product, a service, digital media, or digital content. The financial institution can be one of a bank, savings and loan (S&L), credit union, or Federal Reserve.

Implementations may provide one or more of the following advantages. In one implementation, a fully integrated online check processing system is provided that functions much like credit card authorization and settlement, but is much more universally available to consumers or other users. Unlike transactions involving credit cards or a funds transfer system associated with the ACH network, the electronic images of authorized demand drafts created by the check payment/processing system cannot be easily or readily reversed, and are acceptable at every U.S. bank. Moreover, the check processing system is not subject to NACHA rules and/or other regulatory oversight.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of an online payment system including a check processing system, in accordance with one implementation.

FIG. 2 illustrates a block diagram of the check processing system of FIG. 1, in accordance with one implementation.

FIG. 3 illustrates a method for authorizing a user, in accordance with one implementation.

FIG. 4A illustrates a method for processing an electronic check online. in accordance with a first embodiment

FIG. 4B illustrates a method for processing an electronic check online, in accordance with a second embodiment.

FIGS. 5-14 are screen shots of exemplary graphical user interfaces that can be implemented on, for example, a merchant website.

FIGS. 15-30 illustrate an example electronic image of an authorized demand draft, in accordance with one implementation.

Like reference symbols in the various drawings indicate like elements.

### DETAILED DESCRIPTION OF THE INVENTION

Implementations of the present invention relates generally to data processing, and more particularly to methods and apparatus for processing a bank instrument. The following description is presented to enable one of ordinary skill in the art to make and use the invention and is provided in the context of a patent application and its requirements. Various modifications to implementations and the generic principles and features described herein will be readily apparent to those skilled in the art. Thus, the present invention is not intended to be limited to the implementations shown but is to be accorded the widest scope consistent with the principles and features described herein.

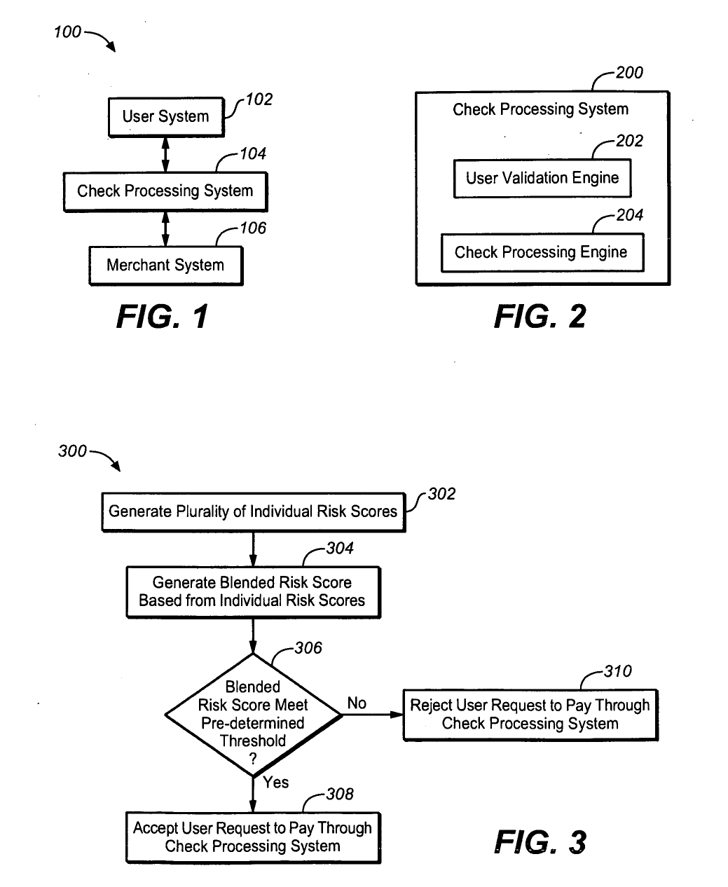

FIG. 1 illustrates an online payment system 100, in accordance with one implementation. In one implementation, the online payment system 100 includes a user system 102, a check processing system 104 and a merchant system 106. In one implementation, the user system 102, the check processing system 104 and the merchant system 106 are interconnected through a network (e.g., the Internet or other wide area network). Other types of networks through which the online payment system 100 can be interconnected include, for example, telephone networks, wireless digital networks, serial cable networks, ATM or credit card networks, or other private networks and collections of networks including intranets, and/or local area networks. In one implementation, the check processing system 104 permits a user (using the user system 102) to pay for items (including, e.g., physical products, services, digital media or content, and the like) that are displayed on (or available/purchasable through) a website, e.g., a merchant website provided by the merchant system 106. A merchant can also enter data to user system 102 while taking an order over the telephone. In one implementation, the check processing system 104 generates an electronic image of an (unsigned) authorized demand draft (or remotely created check), or other bank instrument, (based on user information) that is compliant with the Check Clearing for the 21st Century Act (Check 21), which electronic image is then processed at a financial institution to provide payment for an item. The authorized demand draft can be created in a location remote to the originator. The authorized demand draft can be unsigned and bear a legend in the signature panel that demonstrates authorization. Check 21 compliant formats include, for example, an ANSI (American National Standards Institute) X9.XXX standard such as X9.37, X9.100, or the like. For example, the electronic image can be an embedded TIFF 6, IOCA, PNG, or JPEG file. Such financial institutions include, for example, banks, savings and loans (S&Ls), credit unions, the Federal Reserve, and other check processing centers. In general, the electronic image of the authorized demand draft is a bank instrument corresponding to, for example, a personal check, business check, certified check, bank check, sight draft, demand draft, money order, and the like. Unlike transactions involving credit cards or a funds transfer system associated with the ACH network, the electronic images of authorized demand drafts created by the check processing system 104 cannot be easily or readily reversed and are acceptable at all U.S. banks and other financial institutions.

Check 21 is a new federal law that was signed on Oct. 28, 2003, and became effective on Oct. 28, 2004. Check 21 is designed to foster innovation in the payments system and to enhance efficiency by reducing some of the legal impediments to check truncation. The law facilitates check truncation by creating a new negotiable instrument called a substitute check, which permits banks to truncate original checks, to process check information electronically, and to deliver substitute checks to banks that want to continue receiving paper checks. A substitute check is the legal equivalent of the original check and includes all the information contained on the original check. Accordingly, Check 21 permits banks to process paper checks electronically for faster, more efficient check clearing. Instead of physically moving paper checks between banks, Check 21 permits banks to capture a picture of the front and back of a check and transmit the picture electronically.

Referring to FIG. 1, in one implementation, the electronic image of the authorized demand draft generated by the check processing system 104 is made payable to an entity (e.g., a person or business) associated with the check processing system 104. In this implementation, the check processing system 104 can provide funds received from a financial institution (responsive to a corresponding electronic image of an authorized demand draft) to an entity (e.g. a person or business) associated with the merchant system 106. The check processing system 104 can provide the funds to the merchant system 106 through (e.g.) wire, ACH, or a paper check. In one implementation, the electronic image of the authorized demand draft generated by the check processing system 104 is made payable to an entity associated with the merchant system 106. In this implementation, the funds are provided from the financial institution (or drawee bank) directly to the merchant system 106. In this implementation, the electronic image can be sent directly from the check processing system 104 to the financial institution (or indirectly through a 3^{rd} party or the merchant system 106). For example, the electronic image can first be sent to a bank associated with the merchant system 106, which will then forward the electronic image to the drawee bank. The financial system can provide the funds to the merchant system 106 through (e.g.) wire, ACH, or a paper check. Alternatively, the electronic image of the authorized demand draft generated by the check processing system 104 can be made payable to an entity associated with a 3^{rd} party not associated with the check processing system 104 or the merchant system 106. In this implementation, the settlement of funds for payment of an item is provided by the 3^{rd} party.

In addition to making payments for items that are available through a website, the check processing system 104 can be used to make payments for items generally. For example, the check processing system 104 can be used to provide payment for car payments, insurance payments, mortgage payments, payroll checks, and so on. In one implementation, the check processing system 104 is operable to automatically make recurring payment by generating electronic images of the authorized demand drafts on a pre-determined reoccurring basis. The recurring payments can involve creation of an electronic image of an authorized demand draft based on a previous authorization made for other electronic images.

FIG. 2 illustrates a block diagram of a check processing system 200 (e.g., check processing system 104 of FIG. 1), in accordance with one implementation. In one implementation, the check processing system 200 includes a user validation engine 202 and a check processing engine 204. Although the check processing system 200 is shown as including two separate engines—e.g., the user validation engine 202 and the check processing engine 204—the check processing system can include other engines (not shown) operable to perform the functions described below. In addition, the two separate engines can be combined into a single engine.

In one implementation, the user validation engine 202 performs a series of real-time verifications to ensure that every electronic check (or demand draft) is authorized by a user (or account owner), and that the check will clear the user's bank (or other financial institution associated with the user). More generally, the user validation engine 202 provides bank data, age and identity verification for users of the check processing system 200. In one implementation, the user validation engine 202 generates a blended risk score for each user that registers with the check processing system 200 as described in pending U.S. patent application Ser. No. 10/405,410—entitled “Fraud Control Method and System For Network Transactions”, which is incorporated by reference herein. In one implementation, the blended risk score corresponds to a degree of risk associated with successfully performing an online payment transaction with a given user. For example, a good blended risk score for a user can indicate a greater likelihood of a successful online payment transaction.

For example, referring to FIG. 3, a method 300 for validating a user is shown according to one implementation. A plurality of individual risk scores are generated (e.g., by the user validation engine 202) (step 302). The plurality of individual risk scores can be generated based at least in part on information provided by a user that desires to pay for an item using the check processing system 200. In one implementation, a first individual risk score is generated from a credit history of a user. In this case, the first individual risk score can correspond to a credit score of a given user. In one implementation, a second individual risk score is generated using Network Geolocation Technology (NGT)) to determine a user's physical location, which is compared to a reported location and IP address of the user's (hardware) system. In this implementation, the second individual risk score corresponds to the certainty that a user is physically located near a user system through which the user's information was received. Other individual risk scores can be generated to verify user information and/or bank data using any type of suitable information including for example, publicly maintained databases (e.g., Department of Motor Vehicles (DMV) records, education records, and the like) or privately maintained databases (e.g., Lexis-Nexis, Martindale-Hubbell, and the like).

A blended (or composite) risk score is generated (e.g., by the user validation engine 202) (step 304). In one implementation, the blended risk score is generated by assigning weights to each of the plurality of individual risk scores, substantially according to equation 1 below:

(X)(1st risk score)+(Y)(2nd risk score)+ . . . +(Z)(nth risk score)=blended risk score (eq. 1)

where X, Y, and Z represent a weight assigned to a given risk score. The weights can be assigned to give more (or less) influence to each of the individual risks scores on the (overall) blended risk score. A determination is made (e.g., by the user validation engine 202) whether the blended risk score meets a pre-determined threshold (step 306). The pre-determined threshold can correspond to a level of acceptable risk. If the blended risk score meets the pre-determined threshold then a user request to pay using the check processing system is accepted (e.g., by the user validation engine 202) (step 308). If the blended risk score does not meet the pre-determined threshold then the user request to pay using the check processing system is rejected (e.g., by the user validation engine 202) (step 310).

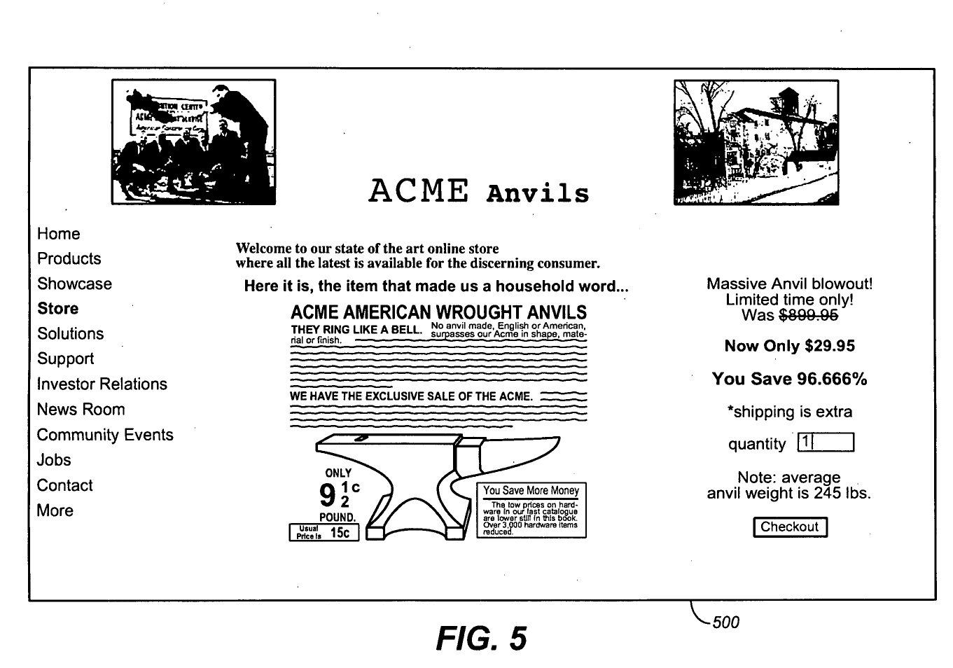

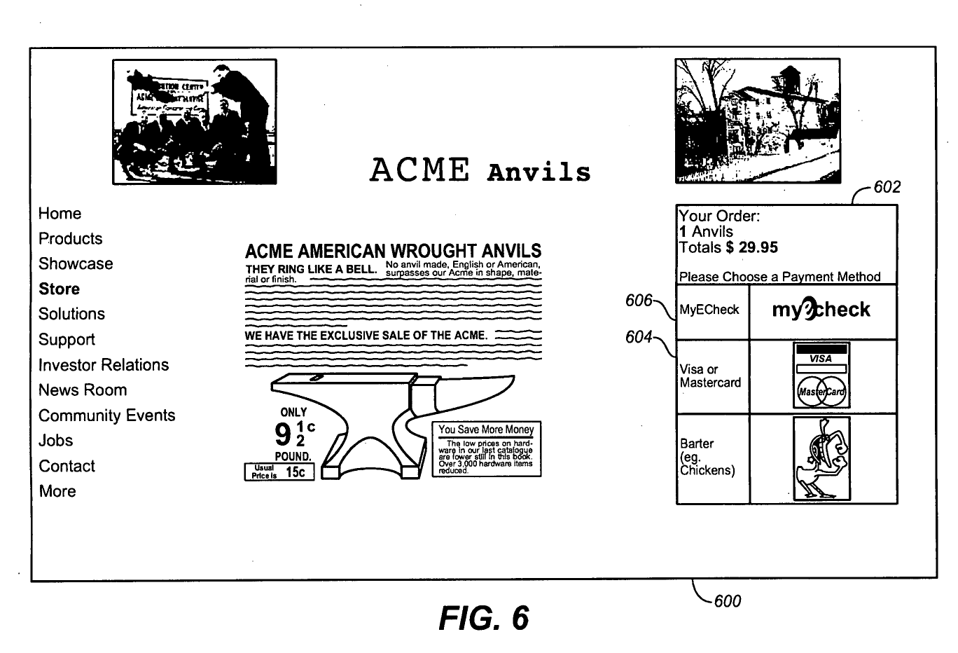

Referring again to FIG. 2, in one implementation, the check processing engine 204 is operable to create an electronic image of an authorized demand draft (or an electronic check) that can be processed to provide online payment for an item. For example, referring to FIG. 5, a screenshot 500 is shown of a user selecting (1) anvil for purchase through a merchant website. As shown in FIG. 6, a screenshot 600 is shown including a window 602 that provides a number of payment options for selection by the user. The window 602 includes a conventional credit card payment option 604 and an electronic check payment option 606 (“MyECheck”) through which an electronic image of an authorized demand draft can be generated to pay for the anvil.

In another implementation, the check processing engine 204 further comprises a printing engine (not shown) and a scanning engine (not shown) and is operable to generate a physical copy of the electronic image. The electronic image is converted back to an image file by, for example, scanning. In one embodiment, printing and scanning require human intervention (e.g., an administrator to move the paper from a printer to a scanner). In another embodiment, printing and scanning are automated in an assembly line configuration (e.g., printing engine fees paper check to scanning engine). In still another embodiment, the image file is printed to a file format such as a JPEG or a PDF file, but remains digital. The JPEG or PDF file is then converted to the image file. Thus, the image file, in this case, comprises a digital copy of a print out of an authorized demand draft. A time period between printing the physical copy and scanning back to a digital copy can be brief, allowing the overall process to occur in substantially real-time (e.g., 10 seconds, 2 minutes, etc.) relative to the conventional process of printing out the check and processing as a piece of paper.

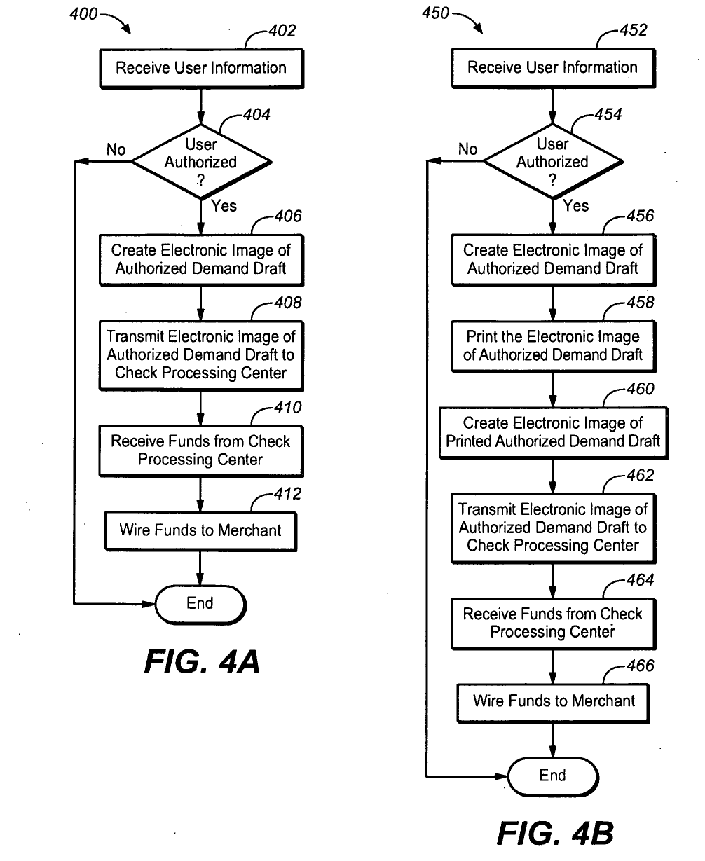

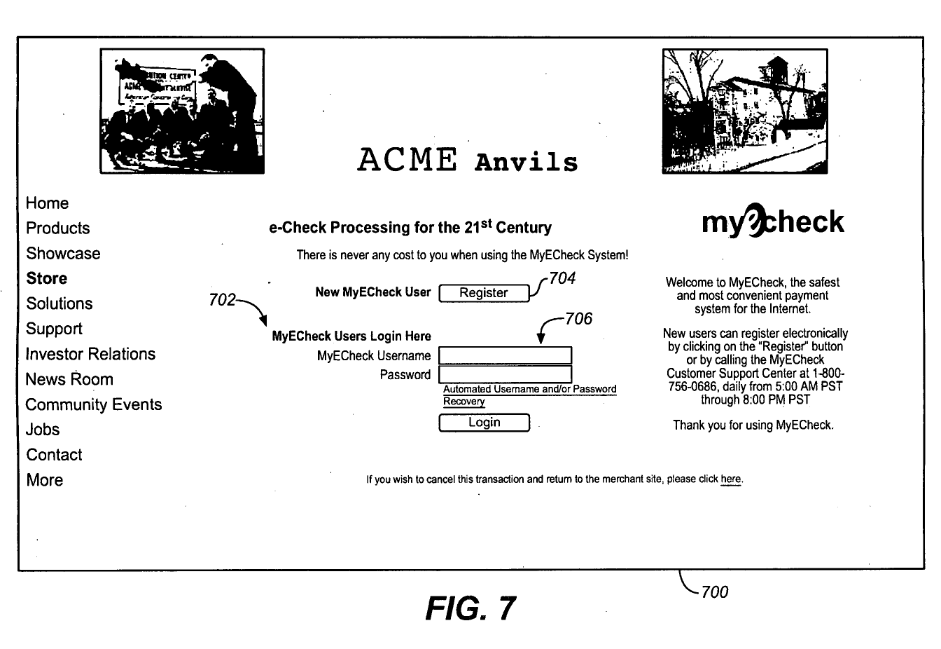

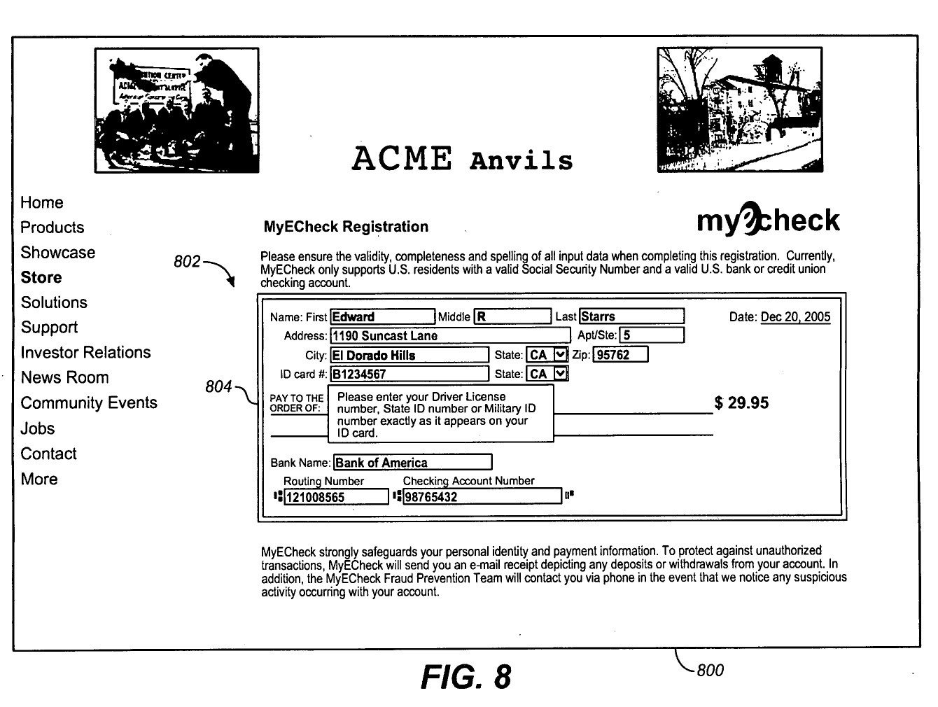

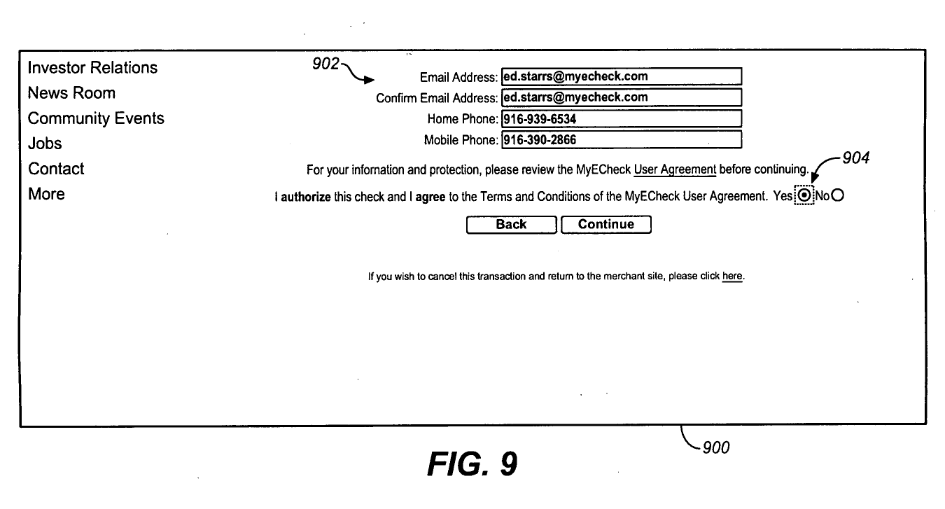

FIGS. 4A and B illustrate implementations of a method for processing an electronic image of an authorized demand draft. As shown in FIG. 4A, user information is received (step 402). In one implementation, the user information is received though a user registration process (i.e., directly from a user or indirectly from a merchant in communication with the user). For example, FIG. 7 shows a screenshot 700 of a login screen 702 that is displayable to a user once the user selects the electronic check payment option 606 (FIG. 6). In one implementation, the login screen 702 includes a registration section 704 for new users and a login section 706 for returning users. If a given user is a returning user, then the user's information can be retrieved from a database or other storage. FIG. 8 shows a screenshot 800 of a registration screen 802 that is displayable to new users of the electronic check payment option. In one implementation, the user information that is received includes date, name, address, driver's license identification number, bank data (e.g., including a bank routing number and a bank account number), payee information, and the amount to be paid. In one implementation, the information is entered directly into an electronic template 804 in the form of a conventional paper check as shown in FIG. 8. As discussed above, the payee can be an entity associated with the check processing system, the merchant system, or a 3^{rd} party. FIG. 9 shows a screenshot 900 of an authorization page 902. In one implementation, the authorization page 902 includes email and telephone contact numbers and includes an authorization selection button 904 indicating a user's authorization of an electronic check.

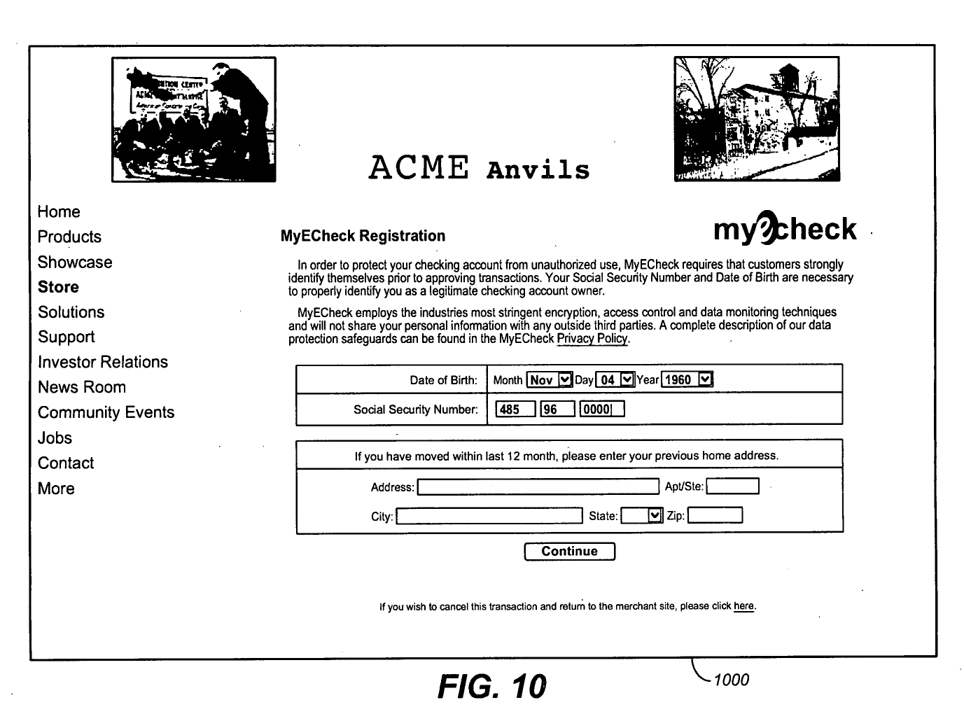

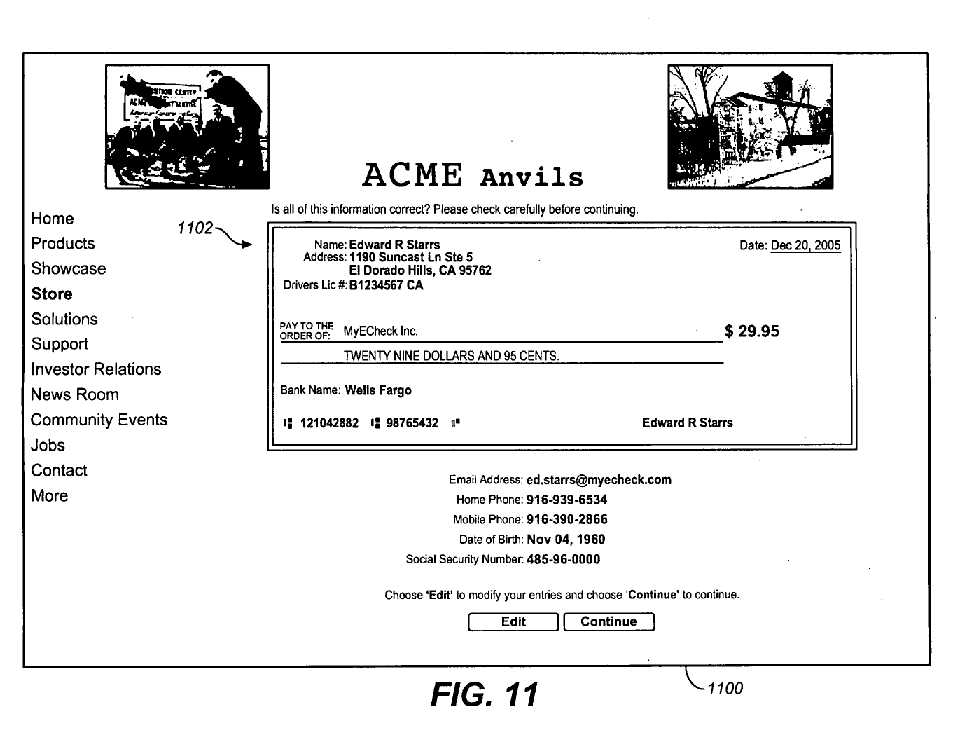

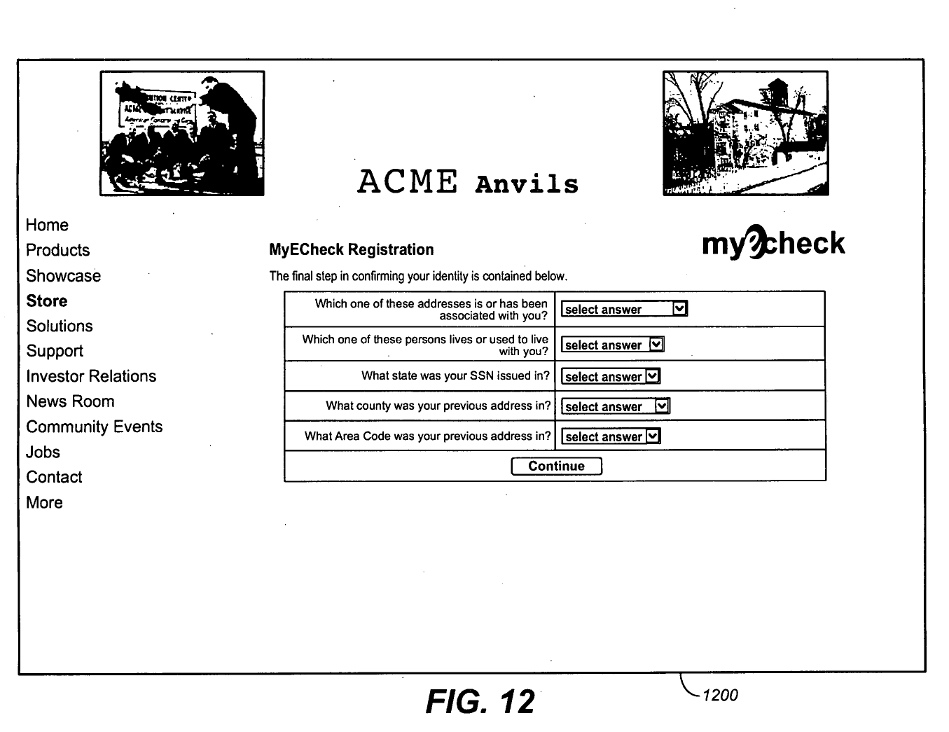

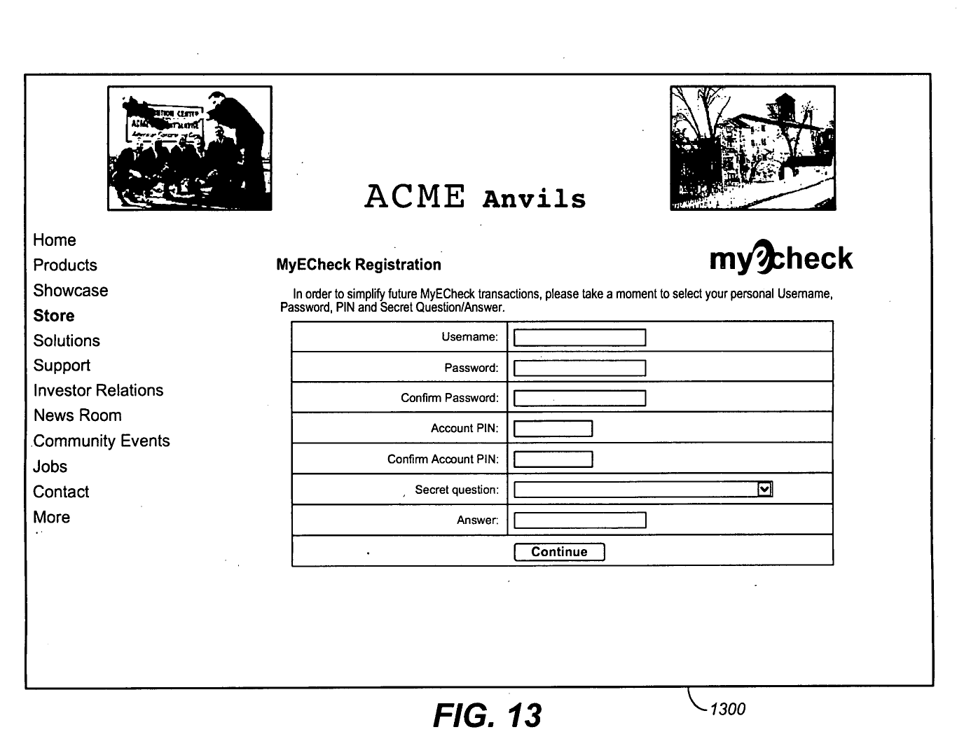

In one implementation, prior to completing registration, a user enters additional personal information including, for example, date of birth, social security number, previous home addresses, and so on, as shown in the screenshot 1000 of FIG. 10. FIG. 11 illustrates a screenshot 1100 of a confirmation page 1102 containing all of the information previously entered by a user. In one implementation, a quiz is presented to a user (e.g., by the user validation engine 202 (FIG. 2)) to further confirm identity of the user as shown in the screenshot 1200 of FIG. 12. The questions can be generated from public and/or private databases, or other information databases. FIG. 13 illustrates a screenshot 1300 of additional information that can be entered by a user to simplify future electronic check payment transactions. The additional information includes a username, password, account PIN (personal identification number), secret question and answer. The secret question and answer can be used to verify identity of a user should the user later forget a username, password, and/or account PIN.

FIG. 4A is a flow chart illustrating a method 400 for online payment processing, according to a first embodiment. A determination is made (e.g., by the user validation engine 202 of FIG. 2) as to whether the user is authorized to complete online payment using the electronic check payment option. In one implementation, a user is authorized to complete an online payment using the electronic check payment option if a blended risk score associated with the user meets a pre-determined threshold as discussed above. If the user is not authorized to complete the online payment, then the process ends. If the user is authorized to complete the online payment using the electronic check payment option, then an electronic image of an authorized demand draft is created (e.g., by the check processing engine 202 of FIG. 2) (step 406). In one implementation, the electronic image of the authorized demand draft is created directly from information provided by a user through a graphical user interface, e.g., running on (or associated with) a website of a merchant. For example, referring to FIG. 8, an electronic image of an authorized demand draft can be created based on the information provided on the electronic template of a conventional check. More generally, the information for generating an electronic image of an authorized demand draft can be received through data collection means or transmittal methods. For example, the information for generating an electronic image of an authorized demand draft can be received from a merchant (or payment gateway). In one implementation, the check processing engine generates electronic images of authorized demand draft in response to transactions that are sent to the check processing engine in batches. For example, a merchant may delay release of payment processing of a previously authorized transaction to the check processing system (e.g., the purchase of a charter flight plane ticket may require the merchant to defer issuance (by hours or days) pending confirmation of seat availability of a carrier).

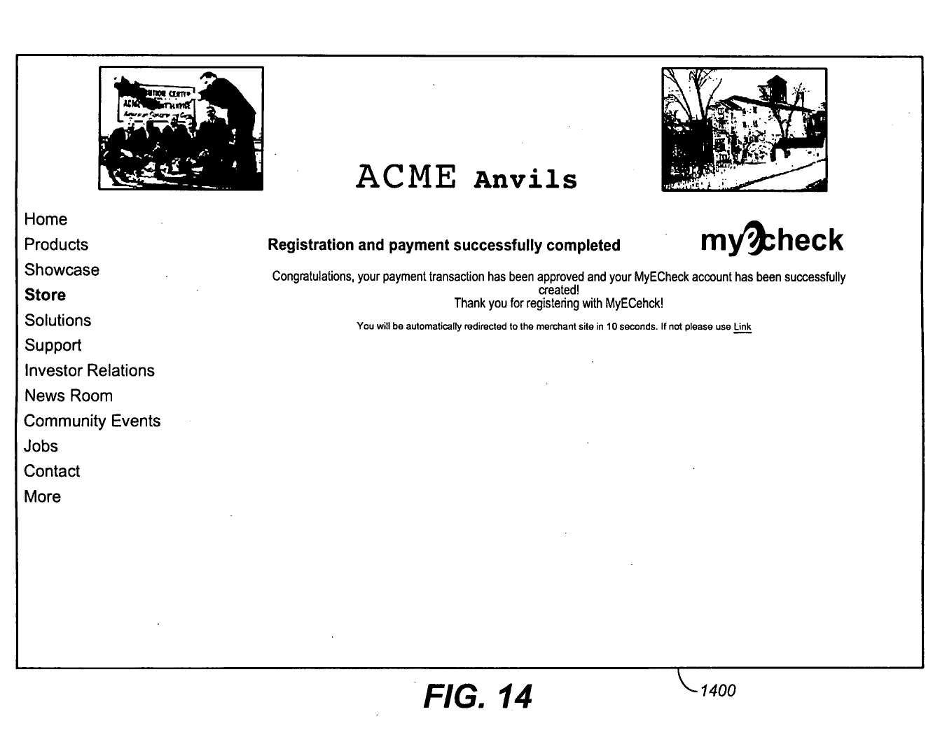

In one implementation, the electronic image of the authorized demand draft is compliant with Check 21 to guarantee that the electronic image of the authorized demand draft will be acceptable at all U.S. banks or other financial institutions. In one implementation, the electronic image of the authorized demand draft is unsigned by the user. Alternatively, an electronic signature can be placed on the electronic image of the authorized demand draft. The electronic image of the authorized demand draft is transmitted (e.g., by the check processing system 200 (FIG. 2)) to a check processing center (e.g., the user's bank or other financial institution such as Endpoint, Viewpointe, Small Value Payments Company (SVPCO), or any other image exchange network) (step 408). In one implementation, the electronic image of the authorized demand draft is transmitted substantially in real-time to the check processing center. Once the electronic image of the authorized demand draft is processed, funds are received (e.g., by the check processing system 200) (step 410). In one implementation, the funds are received by the check processing system substantially in real-time. The funds are then wired to the merchant (step 412). FIG. 14 shows a screenshot 1400 indicating successful online registration and payment through the electronic check payment option. Alternatively, as discussed above, the electronic image of the authorized demand draft can be made payable to the merchant (or a 3^{rd} party), in which case the check processing center (or financial institution) directly sends the funds to the merchant (or the 3^{rd} party).

In an alternative embodiment of the method 400, the method 400 for online payment processing includes data processing steps without actually settling the funds. In other words, once the electronic image is transmitted via step 408, the settling is handled by the check processor via the Federal Reserve (unless there is a negative transaction such as a bounced check). Thus, the method 400 merely performs data processing steps in preparation for the settlement.

FIG. 4B is a flow chart illustrating a method 450 for online check processing, according to a second embodiment. Steps 452, 454, and 456 can be similar to steps 402, 404, and 406 of FIG. 4A. discussed above. Accordingly, user information is received (step 452). The user information can be related to an online transaction. For authorized users (step 454), an electronic image of an authorized demand draft is created (step 456).

In the present embodiment, the electronic image is printed 458. The print out can be a physical printout resulting in a hard copy of the authorized demand draft. In still another embodiment, the electronic image of the authorized demand draft is printed to a file, such as a JPEG file (.jpg) or a PDF file (.pdf). As a result, a physical check is generated prior to transmission to a check processing center. Various merchants or check processor may implement this transitory in order to comply with certain laws or regulations interpreted as requiring that a check be on a tangible medium.

Subsequently, an electronic image of the printed authorized demand draft is created (step 460). In one embodiment, a physical check is scanned to an image format as described herein. In another embodiment, a file (e.g., a JPG file or a PDF file) is converted to the image format.

Steps 462, 464, and 466 are similar to steps 408, 410, ad 412 discussed above. Accordingly, the electronic image of the authorized demand draft is transmitted to a check processing center (step 462). Funds from the check processing center are received (step 464). Finally, the funds are wired to the merchant 466.

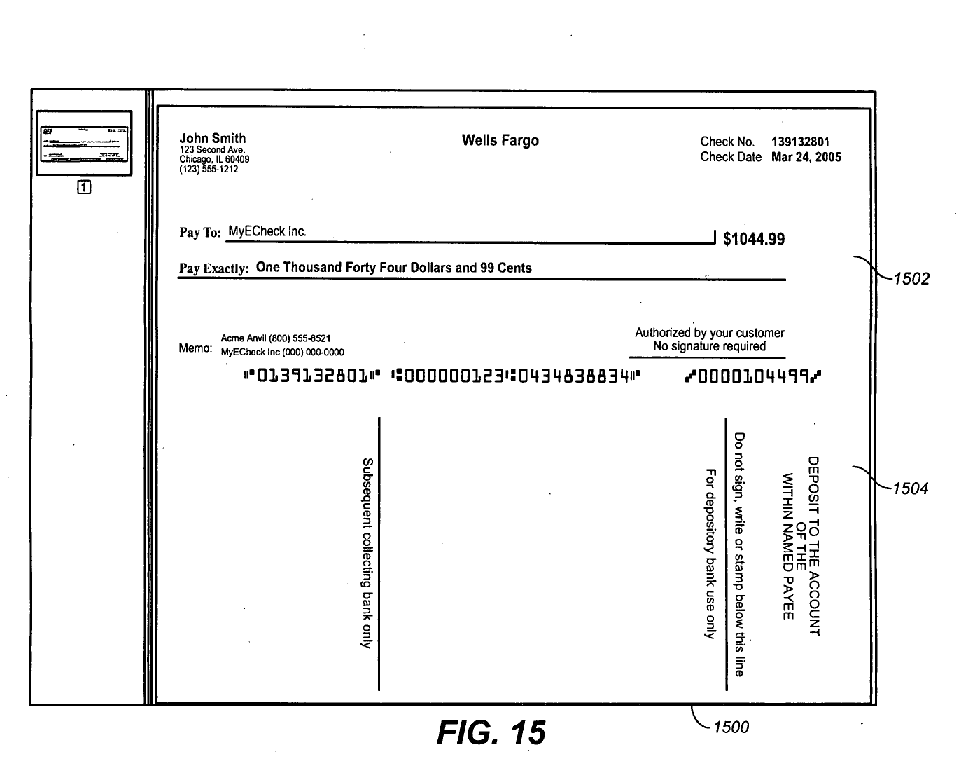

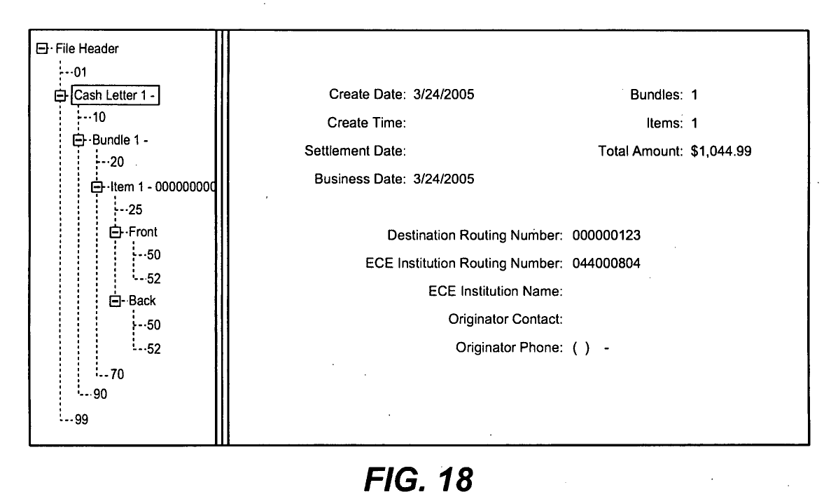

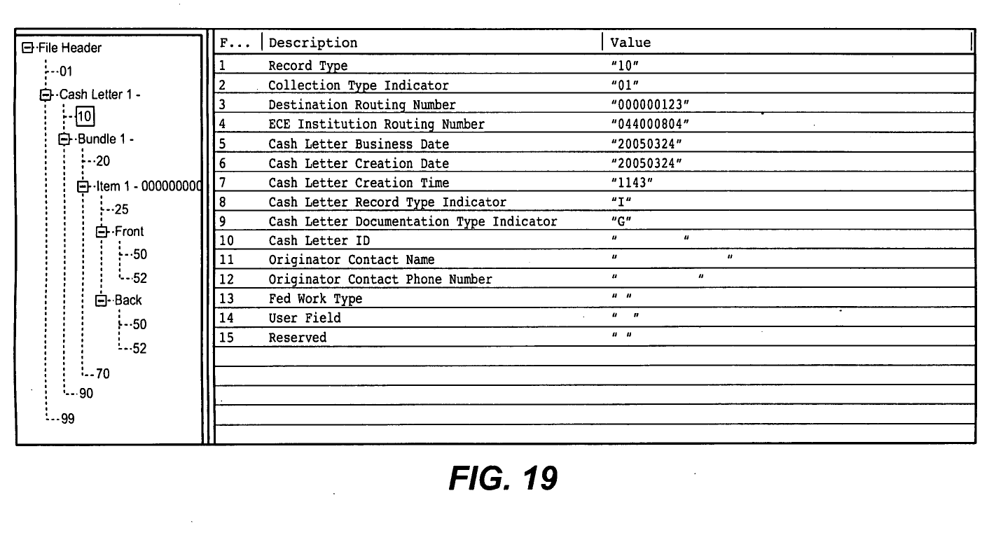

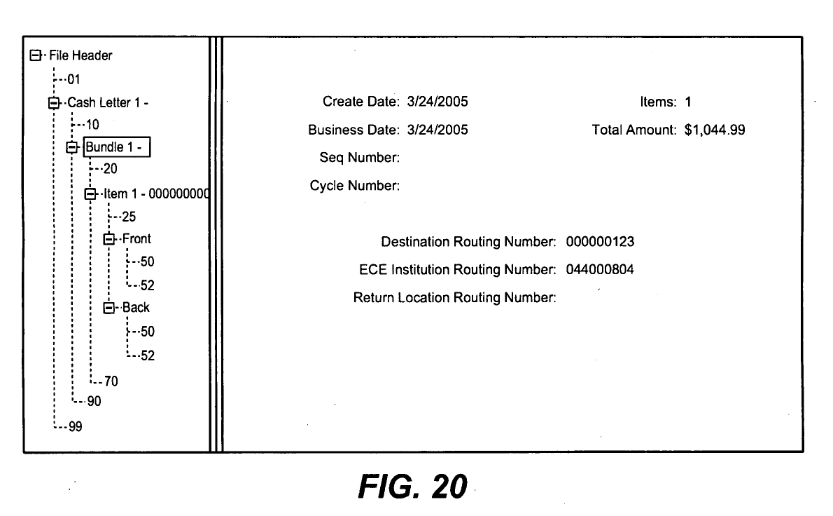

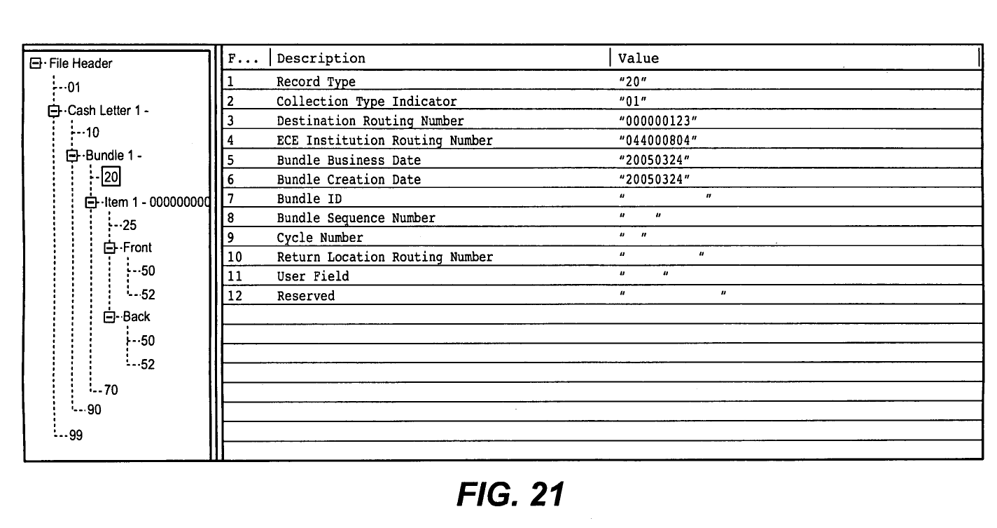

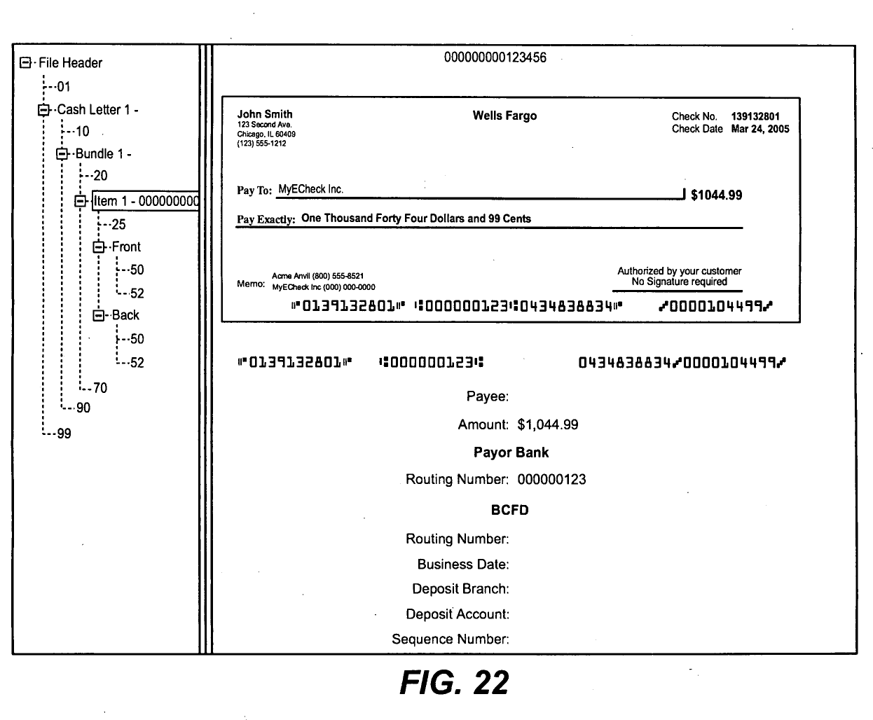

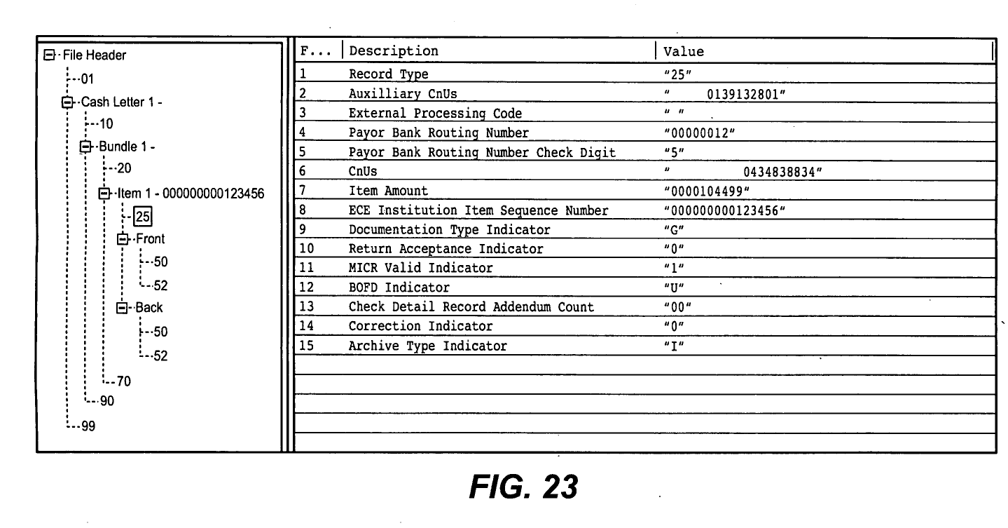

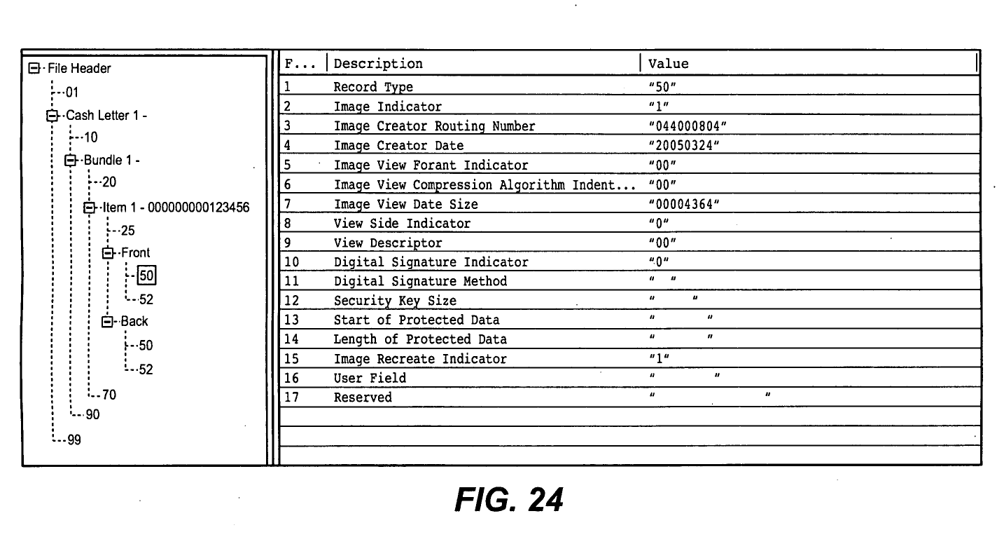

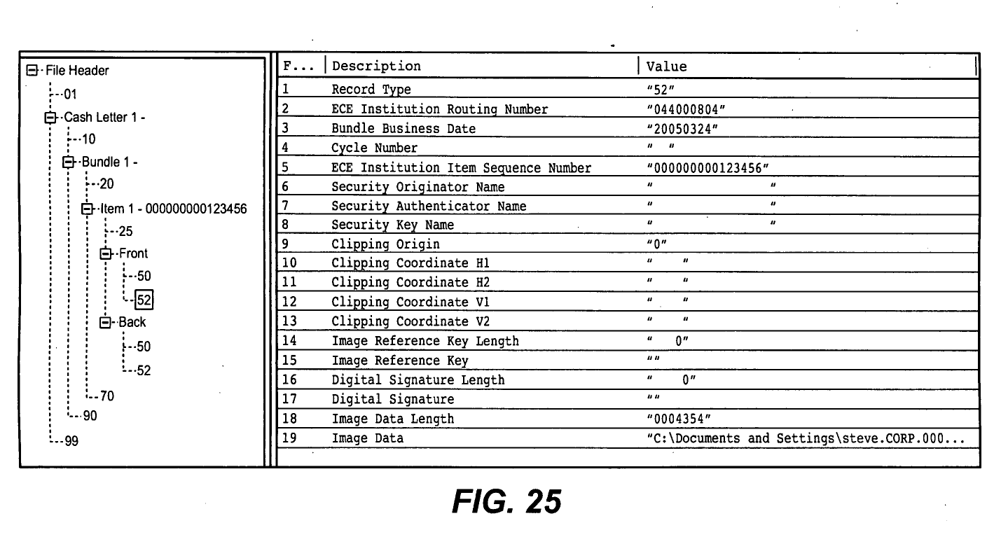

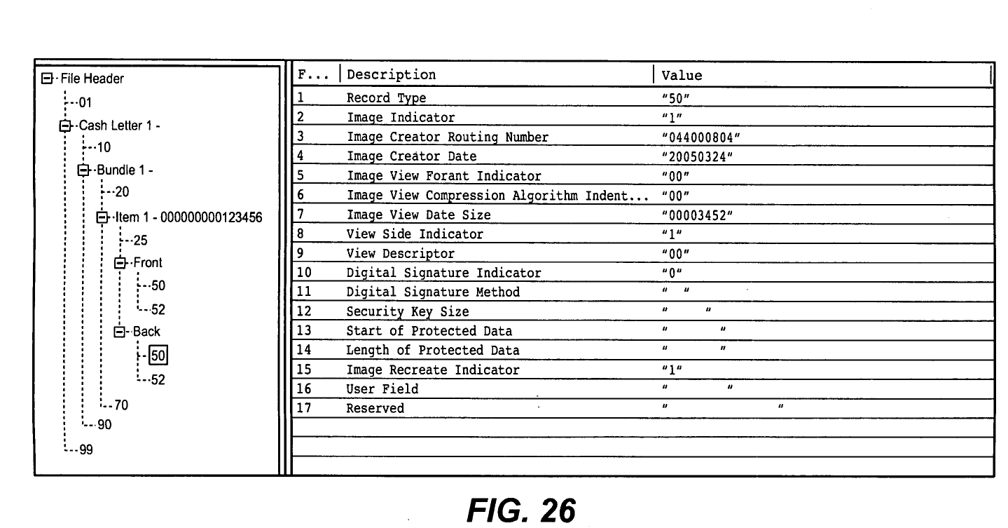

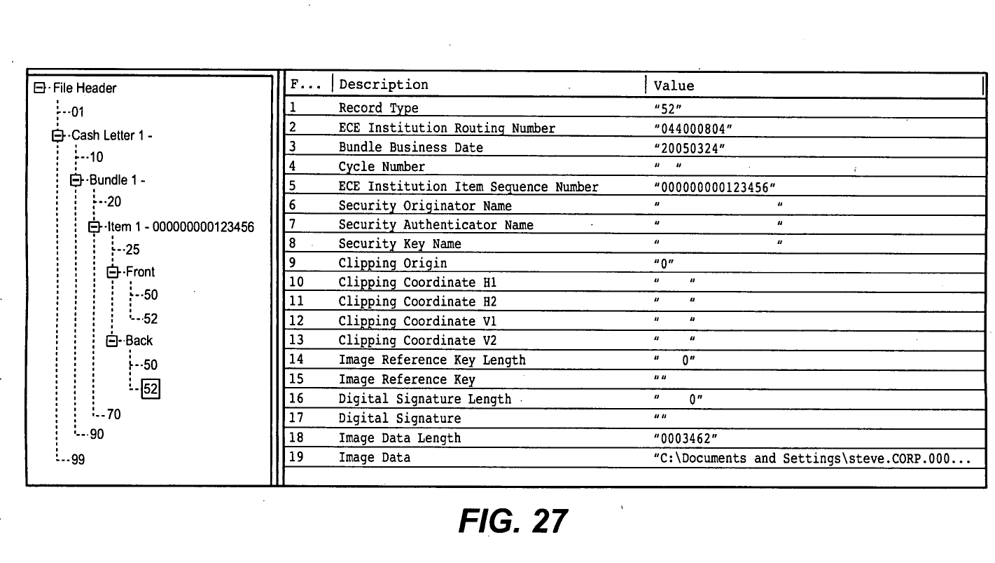

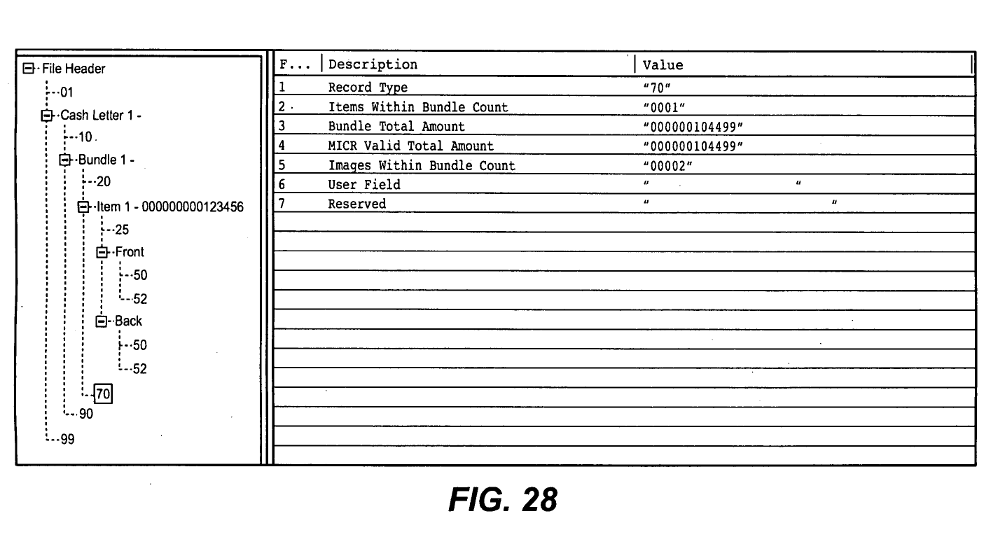

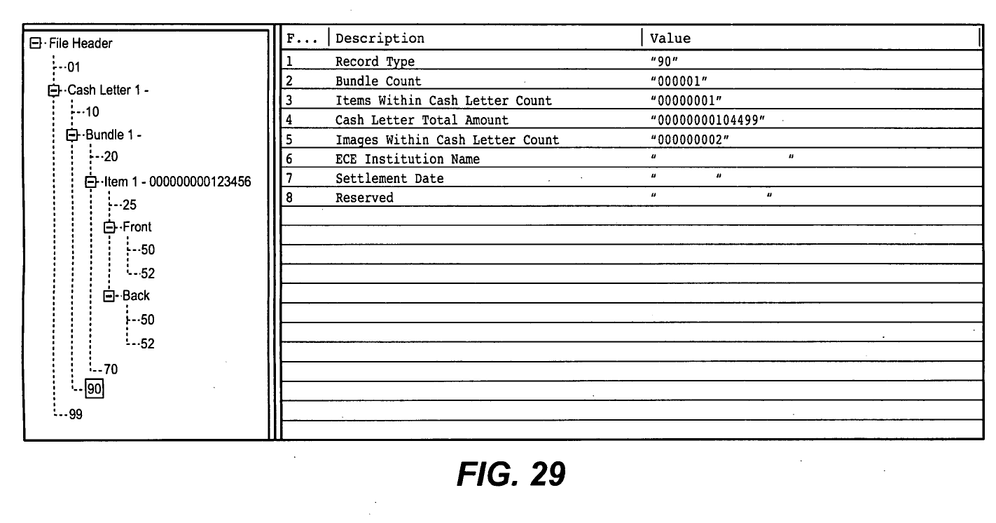

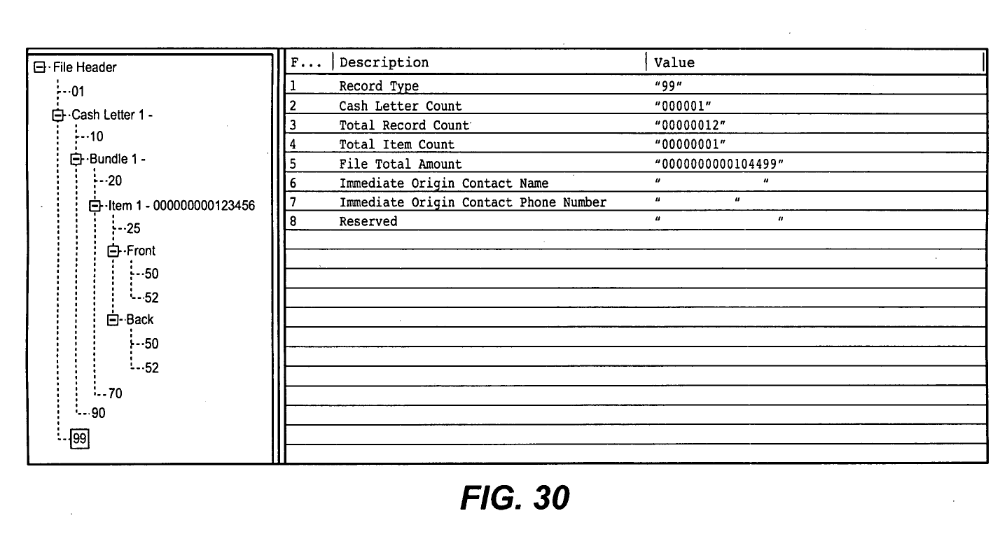

FIGS. 15-30 illustrate one implementation of an electronic image of an authorized demand draft, and components (or data sources) thereof. In general, various financial institutions have different requirements regarding acceptance of an electronic image of an authorized demand draft and, therefore, the electronic image (and components thereof) shown in FIGS. 15-30 are exemplary.

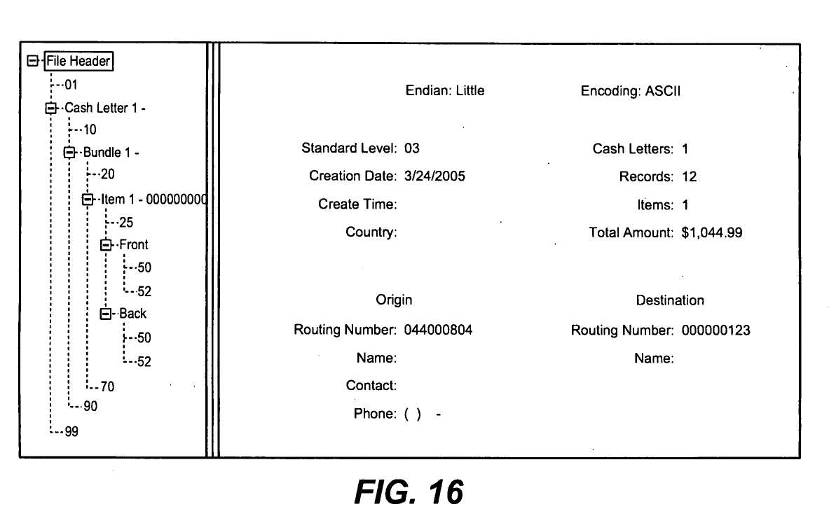

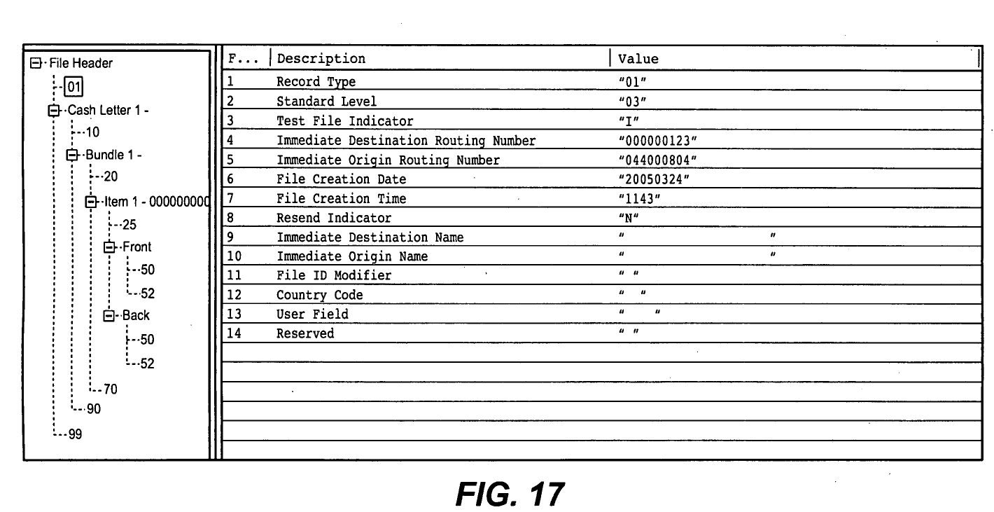

Referring first to FIG. 15, one implementation of an electronic image of an authorized demand draft 1500 is shown. The electronic image of an authorized demand draft 1500 includes a front side 1502 and a back side 1504. As shown on the front side 1502, the electronic image of an authorized demand draft 1500 is unsigned. FIG. 16 shows file header that is associated with the electronic image of an authorized demand draft 1500. In one implementation, the file header includes origin and destination routing number information as shown, in addition to the total amount ($1044.99) to be transferred between the two accounts associated with the routing numbers. FIGS. 17-30 respectively illustrates other components (or data sources) that can be associated with the electronic image of an authorized demand draft 1500 including, for example, a record type 01, a cash letter, a record type 10, a bundle, a record type 20, an item identifier (item 1), a record type 25, a record type 50 (associated with the front side 1502), a record type 52 (associated with the front side 1502), a record type 50 (associated with the back side 1504), a record type 52 (associated with the back side 1504), a record type 70, a record type 90, and a record type 99.

Below is provided an exemplary process steps that can occur through a merchant website and a check processing system that is in accordance with the method steps discussed above.

### 1) Merchant Web Site

Merchant collects amount of item

Customer selects Check Processing System to pay for item

2) Check Processing System creates secure session with Customer inside frames on Merchant Web Site

Amount of item is electronically sent to Check Processing System

Check Processing System creates a unique session ID and transaction ID

Check Processing System serves a log-in page

Pre-registered users log-in user username and password, and new users click through to register

### 3) (a) New User Registration

Check Processing System serves customer registration pages

Customer enters name, address, phone number, driver license number, bank name, bank routing number, bank account number into fields on blank check image

Customer enters phone numbers, date of birth, other addresses, social security number into additional fields

Customer agrees to terms of use and authorizes transaction

Customer's identity attributes are verified by Check Processing System matching customer provided data with data in external private and public records databases

Check Processing System serves interactive quiz to customer to validate identity

Check Processing System verifies customer bank account funds availability through interfaces with external data providers

Check Processing System queries external negative check writer databases

Check Processing System uses risk assessment and decision tools to approve or decline transaction

Check Processing System serves Approved or Declined page to Customer, declined customers are redirected to the merchant web site

Check Processing System serves page for approved customer to enter a username, password, PIN and secret question to identify themselves to the Check Processing System on future transactions.

Customer and transaction data is posted to the Check Processing System database

Customer is redirected to the merchant website along with transaction data

An electronic, Check 21 compliant file containing an image of authorized demand draft is created and electronically sent to a financial institution for processing

Check Processing System sends receipt to customer email

### 3)(b) Pre-Registered Users

Check Processing System serves page containing image of demand draft for customer approval or editing

Customer enters PIN to authorize demand draft

Transaction data is posted to the Check Processing System database

Customer is redirected to the merchant website along with transaction data

An electronic, Check 21 compliant file containing an image of authorized demand draft is created and electronically sent to a financial institution for processing

Check Processing System sends receipt to customer email address

One or more of method steps described above can be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in specially-designed ASICs (application-specific integrated circuits).

To provide for interaction with a user, the invention can be implemented on a computer system having a display device such as a monitor or LCD screen for displaying information to the user, and a keyboard and a pointing device (e.g., a mouse or a trackball) by which the user can provide input to the computer system. The computer system can be programmed to provide a graphical user interface through which the computer programs interact with users.

Various implementations of an online payment system and methods for providing payment online have been described. Nevertheless, one of ordinary skill in the art will readily recognize that various modifications may be made to the implementations, and those variations would be within the scope of the present invention. For example, the steps of methods discussed above can be performed in a different order to achieve desirable results. In addition, although FIG. 1 depicts the user system 102, the check processing system 104 and the merchant system 106 as separate systems, two or more of the systems can be combined within a single system. Accordingly, many modifications may be made by one of ordinary skill in the art without departing from the spirit and scope of the following claims.

1. A computer-implemented method for processing an online payment from a user, the online payment being for an item that is purchasable through a website of a merchant, the method comprising:
receiving information from the user corresponding to the online payment for the item, the information from the user being received through a graphical user interface associated with the website of the merchant, the information from the user including a name of the user, bank data associated with the user, and an authorization to pay for the item using an electronic check;
creating an electronic image of an authorized demand draft based on the authorization received from the user, the electronic image of the authorized demand draft including the name of the user, the bank data associated with the user;
generating a printed version of the electronic image of the authorized demand draft to a financial institution;
creating an electronic image of the printed version of the authorized demand draft to the financial institution;
transmitting the electronic image of the printed version of the authorized demand draft to the financial institution corresponding to the bank data associated with the user; and
receiving funds from the financial institution based on the electronic image of the authorized demand draft to provide payment for the item,
wherein creating the electronic image of the authorized demand draft, transmitting the electronic image of the printed version of the authorized demand draft to the financial institution, and receiving funds from the financial institution based on the electronic image of the printed version of the authorized demand draft are performed in substantially real-time.

2. The method of claim 1, wherein creating the electronic image of the authorized demand draft includes creating an electronic image of an authorized demand draft that is compliant with the Check Clearing for the 21st Century Act (Check 21).

3. The method of claim 2, wherein the Check 21 compliant format comprises an ANSI X9 type of format.

4. The method of claim 3, wherein the ANSI X9 type of format comprises either an ANSI X9.37 format or an ANSI X9.100 format.

5. The method of claim 1, wherein the generating the printed version of the authorized demand draft includes printing the electronic image on paper.

6. The method of claim 1, wherein the generating the printed version of the authorized demand draft includes printing the electronic image to a file.

7. The method of claim 1, wherein the creating the electronic image of the printed version of the authorized demand draft includes an administrator scanning the printed version.

8. The method of claim 1, wherein the creating the electronic image of the printed version of the authorized demand draft includes automatically creating the electronic image from the printed version.

9. The method of claim 1, wherein the generating a printed version of the authorized demand draft and the creating the image of the printed version of the authorized demand draft are performed in substantially real-time.

10. A check processing system for processing an online payment from a user, the online payment being for an item that is purchasable through a website of a merchant, the system comprising:
a first engine configured to receive information from the user corresponding to the online payment for the item, the information from the user being received through a graphical user interface associated with the website of the merchant, the information from the user including a name of the user, bank data associated with the user, and an authorization to pay for the item using an electronic check;
a second engine, coupled to the first engine, the second engine configured to create an electronic image of an authorized demand draft based on the authorization received from the user, the electronic image of the authorized demand draft including the name of the user, the bank data associated with the user, wherein the second engine further comprises:
a print engine configured to generate a printed version of the electronic image of the authorized demand draft to the financial institution, and
a scan engine to create an electronic image of the printed version of the authorized demand draft to the financial institution;
a third engine, coupled to the second engine, the third engine configured to transmit the electronic image of the authorized demand draft to a financial institution corresponding to the bank data associated with the user; and
a fourth engine, coupled to the third engine, the fourth engine configured to receive funds from the financial institution based on the electronic image of the authorized demand draft to provide payment for the item,
wherein the fourth engine is operable to receive the funds from the financial institution in substantially real-time relative to when the electronic image of the authorized demand draft is created and transmitted to the financial institution.

11. The system of claim 10, wherein creating the electronic image of the authorized demand draft includes creating an electronic image of an authorized demand draft that is compliant with the Check Clearing for the 21st Century Act (Check 21).

12. The system of claim 11, wherein the Check 21 compliant format comprises an ANSI X9 type of format.

13. The system of claim 12, wherein the ANSI X9 type of format comprises either an ANSI X9.37 format or an ANSI X9.100 format.

14. The system of claim 10, wherein the printing engine is configured to print the electronic image on paper.

15. The system of claim 10, wherein the printing engine is configured to print the electronic image to a file.

16. The system of claim 10, wherein the scanning engine is configured for an administrator to scan the printed version.

17. The system of claim 10, wherein the scanning engine is configured to automatically create the electronic image from the printed version.

18. The system of claim 10, wherein the printing engine and the scanning engine are configured to perform in substantially real-time.

19. A computer-implemented method for processing an online payment from a user, the online payment being for an item that is purchasable through a website of a merchant, the method comprising:
receiving information from the user corresponding to the online payment for the item, the information from the user being received through a graphical user interface associated with the website of the merchant, the information from the user including a name of the user, bank data associated with the user, and an authorization to pay for the item using an electronic check;
creating an electronic image of an authorized demand draft based on the authorization received from the user, the electronic image of the authorized demand draft including the name of the user, the bank data associated with the user;
generating a printed version of the electronic image of the authorized demand draft to a financial institution;
creating an electronic image of the printed version of the authorized demand draft to the financial institution;
transmitting the electronic image of the printed version of the authorized demand draft to a check processing system corresponding to the bank data associated with the user; and
wherein creating the electronic image of the authorized demand draft, and transmitting the electronic image of the printed version of the authorized demand draft to the financial institution, are performed in substantially real-time.

20. The method of claim 19, wherein the check processing system comprises one from the group consisting of: Endpoint, Viewpointe, Small Value Payments Company (SVPCO), or an image exchange network.
